(19) United States
(12) Patent Application Publication
(10) Pub. No.: US 2016/0055127 A1
(43) Pub. Date: Feb. 25, 2016

(54) DISPLAY CONTROL DEVICE, TERMINAL APPARATUS, NON-TRANSITORY COMPUTER READABLE MEDIUM, AND DISPLAY CONTROL METHOD

(71) Applicant: FUJI XEROX CO., LTD., Tokyo (JP)

(72) Inventors: Daisuke YASUOKA, Kanagawa (JP); Yuki SHIMIZU, Kanagawa (JP); Yuko ABE, Kanagawa (JP)

(73) Assignee: FUJI XEROX CO., LTD., Tokyo (JP)

(21) Appl. No.: 14/605,103

(22) Filed: Jan. 26, 2015

(30) Foreign Application Priority Data
Aug. 21, 2014 (JP) 2014-168468

(51) Int. Cl. G06F 17/21

(52) U.S. Cl. CPC G06F 17/211

(57) ABSTRACT

A display control device includes a memory controller, a display controller, and a notification unit. The memory controller causes a document file managed by a document management apparatus to be stored in a memory. The display controller causes a document represented by the document file stored in the memory to be displayed over an entire range of a display area of a display during a presentation. The notification unit notifies a user of presence of a difference between the document file stored in the memory and the document file managed by the document management apparatus, while the document is being displayed over the entire range of the display area, by displaying the difference in an area where the document is being displayed.

### CROSS-REFERENCE TO RELATED APPLICATIONS

This application is based on and claims priority under 35 USC 119 from Japanese Patent Application No. 2014-168468 filed Aug. 21, 2014.

### BACKGROUND

(i) Technical Field

The present invention relates to a display control device, a terminal apparatus, a non-transitory computer readable medium, and a display control method.

(ii) Related Art

In a system for displaying a document, a process for synchronization between a document file managed by a server apparatus and a document file managed by a client apparatus is available.

### SUMMARY

According to an aspect of the invention, there is provided a display control device including a memory controller, a display controller, and a notification unit. The memory controller causes a document file managed by a document management apparatus to be stored in a memory. The display controller causes a document represented by the document file stored in the memory to be displayed over an entire range of a display area of a display during a presentation. The notification unit notifies a user of presence of a difference between the document file stored in the memory and the document file managed by the document management apparatus, while the document is being displayed over the entire range of the display area, by displaying the difference in an area where the document is being displayed.

### BRIEF DESCRIPTION OF THE DRAWINGS

An exemplary embodiment of the present invention will be described in detail based on the following figures, wherein:

FIG. 1 illustrates an overall configuration of a document management system according to an exemplary embodiment;

FIG. 2 is a block diagram illustrating a hardware configuration of a terminal apparatus according to the exemplary embodiment;

FIG. 3 is a block diagram illustrating a hardware configuration of the document management apparatus according to the exemplary embodiment;

FIG. 4 is a block diagram illustrating a functional configuration of the document management system according to the exemplary embodiment;

FIG. 5 is a sequence diagram illustrating a process for the document management system to display a document;

FIG. 6 is a sequence diagram illustrating the document management system, and illustrates a continued part of FIG. 5;

FIGS. 7A to 7C illustrate document file storage control in the document management system;

FIGS. 8A to 8D illustrate an example display of documents on the terminal apparatus;

FIGS. 9A to 9D illustrate an example display of documents on the terminal apparatus;

FIG. 10 is a sequence diagram illustrating a process for the document management system to update a document;

FIGS. 11A to 11D illustrate an example display of documents on the terminal apparatus;

FIGS. 12A and 12B illustrate an example display of documents on a terminal apparatus according to a first modification;

FIG. 13 illustrate an example display of documents on the terminal apparatus according to the first modification; and

FIGS. 14A to 14C illustrate document file storage control of a document management system according to a second modification.

### DETAILED DESCRIPTION

An exemplary embodiment of the present invention will be described with reference to the drawings.

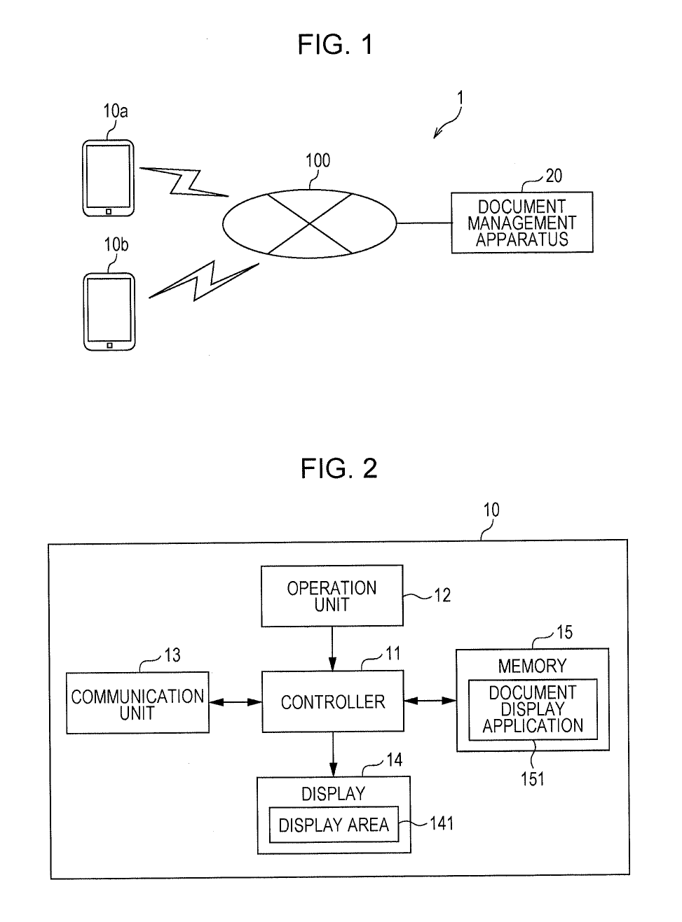

FIG. 1 illustrates an overall configuration of a document management system 1 according to an exemplary embodiment of the present invention. The document management system 1 includes multiple terminal apparatuses 10 (10a and 10b) and a document management apparatus 20. The multiple terminal apparatuses 10 and the document management apparatus 20 are each connected to a communication line 100. The communication line 100 is a public communication line, examples of which may include a mobile communication network, a gateway device, and the Internet, or may be any other communication line (or communication network) such as a local area network (LAN).

In FIG. 1, two terminal apparatuses 10a and 10b are illustrated as an example of the terminal apparatuses 10. More than two terminal apparatuses may be used. In addition, more than one document management apparatus 20 may be used. In the following, the terminal apparatuses 10 are sometimes individually referred to as the terminal apparatus 10 and collectively referred to as the terminal apparatuses 10, unless otherwise individually designated.

Here, the terminal apparatus 10 is a touch panel wireless communication terminal. The terminal apparatus 10 is a tablet terminal, by way of example, or may be a smartphone, a personal digital assistant (PDA), or any other similar device. The terminal apparatus 10 corresponds to a client apparatus with respect to the document management apparatus 20. The terminal apparatus 10 acquires a document file from the document management apparatus 20, and displays a document represented by the acquired document file in a display area 141.

The document management apparatus 20 is a management apparatus that manages multiple document files using a database (a document DB 232 described below). The document management apparatus 20 corresponds to a server apparatus with respect to the terminal apparatus 10. In response to a request from the terminal apparatus 10, the document management apparatus 20 transmits a document file to the terminal apparatus 10 via the communication line 100.

A document file is a file representing a document having one or multiple pages, each of which is one of the units making up the document. The document file is a document file representing presentation material, by way of example, and represents a document which may include text, symbols, and other graphical elements such as figures, animations, and photographs. The file format of the document file is not limited to any specific format.

Examples of the file format include Hypertext Markup Language (HTML). A document of this type is often displayed by the user of the terminal apparatus 10 in order to allow other people to view the document. For this reason, the user often increases the document size to display the document in, for example, full-screen mode. In this exemplary embodiment, the term “displaying a document in full-screen mode” refers to displaying a document by using the entire display area 141 as an area over which one document is displayed (hereinafter referred to as a “document display area”). Thus, in a case where a document is displayed in a window, the frame of the window is not displayed when the document is displayed in full-screen mode. When the document is displayed in full-screen mode, furthermore, notification areas presenting information to the user, such as the title bar, the menu bar, and the task bar, which may be displayed by a function of an operating system (OS) or the like, are also not displayed. For example, in a presentation mode, the document may be displayed in full-screen view. The presentation mode is a mode in which an operator displays a document in full-screen view to make a presentation on the document to persons other than the operator. In the presentation mode, by way of example, a cursor mouse is displayed superimposed on top of the document in accordance with instructions given by the operator. In the presentation mode, however, an operation for editing text or an image included in the document is not accepted.

FIG. 2 is a block diagram illustrating a hardware configuration of the terminal apparatus 10. As illustrated in FIG. 2, the terminal apparatus 10 includes a controller 11, an operation unit 12, a communication unit 13, a display 14, and a memory 15.

The controller 11 is a microcomputer including a central processing unit (CPU) serving as an arithmetic operation unit, a read only memory (ROM), and a random access memory (RAM). The CPU reads a program stored in the ROM onto the RAM and executes the read program to control each unit of the terminal apparatus 10. The controller 11 is an example of a display control device according to an exemplary embodiment of the present invention, and performs control for the terminal apparatus 10 to display a document.

The operation unit 12 is an operation device operated by a user. The operation unit 12 has a touch screen including a sensor that is superimposed on the display area 141 and that is formed into a planar shape, and detects an operation of the user on the display area 141 in accordance with, for example, the resistive membrane method or the electrostatic capacitive method. The operation unit 12 may have physical keys such as push buttons, instead of a touch screen.

The communication unit 13 includes, for example, a wireless communication circuit and an antenna, and accesses the communication line 100 to perform communication (wireless communication). The communication unit 13 may additionally perform wireless LAN communication complying with Wi-Fi (registered trademark) or may perform wireless communication complying with any other communication standard.

The display 14 has, for example, a liquid crystal display, and displays various screens in the display area 141. The display 14 includes, for example, a video RAM (VRAM), and displays an image (or a screen) in the display area 141 in accordance with image data (for example, bitmap data) written in the VRAM.

The memory 15 is a storage device including, for example, an electronically erasable and programmable ROM (EEPROM) or a flash memory and configured to store various data. The memory 15 stores an OS installed in the terminal apparatus 10, and a document display application 151 operating on the OS. The document display application 151 is an application program used to display a document. The memory 15 temporarily or permanently stores a document file acquired from the document management apparatus 20.

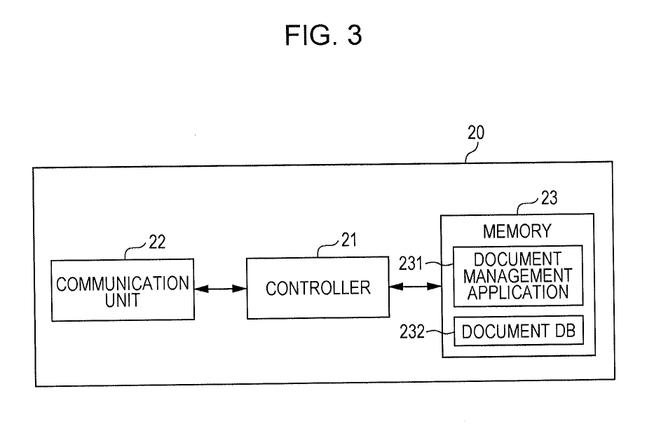

FIG. 3 is a block diagram illustrating a hardware configuration of the document management apparatus 20. As illustrated in FIG. 3, the document management apparatus 20 includes a controller 21, a communication unit 22, and a memory 23.

The controller 21 is a microcomputer including a CPU serving as an arithmetic operation unit, a ROM, and a RAM. The CPU reads a program stored in the ROM onto the RAM and executes the program to control each unit of the document management apparatus 20. The communication unit 22 includes, for example, a modem, and accesses the communication line 100 to perform communication.

The memory 23 is a storage device including, for example, a hard disk device and configured to store a document management application 231 and the document DB 232. The document management application 231 is an application program used to manage document files. The document DB 232 is a database including a set of document files. The document DB 232 has document information for each of the document files. The document information includes information for determining whether or not a document represented by the document file has been updated. Here, the document information includes information concerning the last update date and time and file size of the document file. Here, furthermore, the document information is internal data (for example, property data) of the document file. The document information may also be external data associated with the document file. The document DB 232 may be stored in an external storage device connected to the document management apparatus 20.

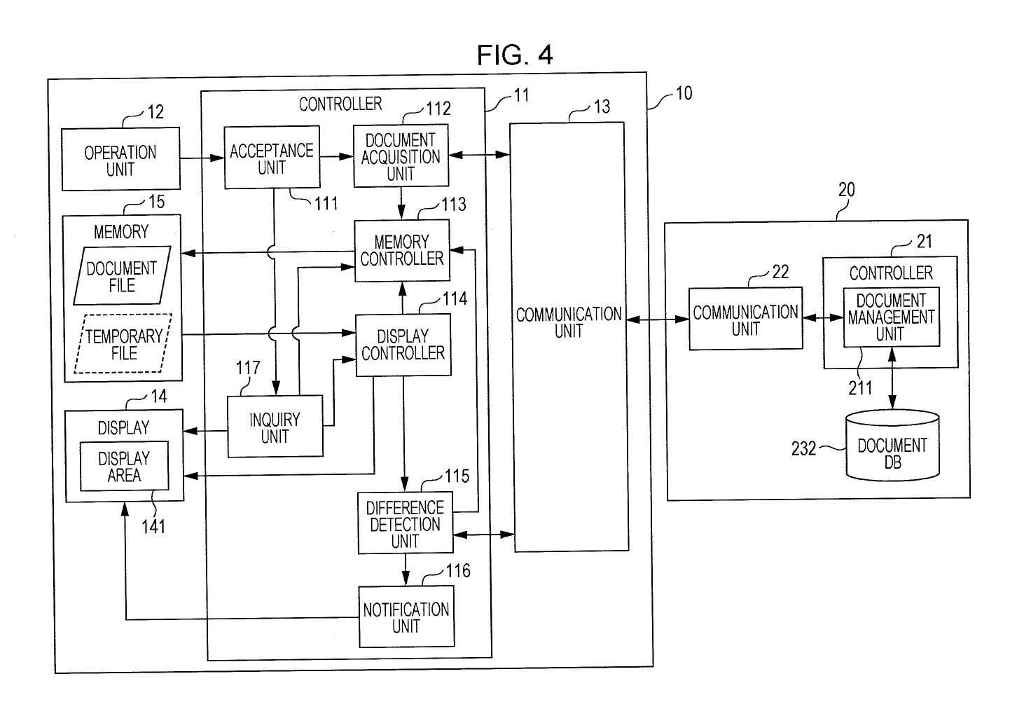

FIG. 4 is a block diagram illustrating a functional configuration of the document management system 1. As illustrated in FIG. 4, the controller 11 of the terminal apparatus 10 executes the document display application 151 to implement the functions corresponding to an acceptance unit 111, a document acquisition unit 112, a memory controller 113, a display controller 114, a difference detection unit 115, a notification unit 116, and an inquiry unit 117.

The acceptance unit 111 is an example of an acceptance unit according to an exemplary embodiment of the present invention, and accepts an operation performed by a user on the operation unit 12. The acceptance unit 111 accepts, for example, an operation to designate a position on the display area 141 by using the touch screen of the operation unit 12.

The document acquisition unit 112 is an example of an acquisition unit according to an exemplary embodiment of the present invention, and acquires a document file from the document management apparatus 20 via the communication unit 13.

The memory controller 113 is an example of a memory controller according to an exemplary embodiment of the present invention, and causes the document file acquired by the document acquisition unit 112 to be stored in the memory 15. The memory controller 113 causes the acquired document file to be stored as a transient file (also referred to as a “temporary file”) and then permanently stored as a document file to be used to display a document. The temporary file is a document file temporarily stored in the memory 15. In this exemplary embodiment, a temporary file is not used to display a document.

The display controller 114 is an example of a display controller according to an exemplary embodiment of the present invention, and causes a document represented by a document file stored in the memory 15 to be displayed on the display 14 in full-screen mode. The display controller 114 also causes any other screen related to the display of a document to be displayed on the display 14.

The difference detection unit 115 is an example of a detection unit according to an exemplary embodiment of the present invention, and detects a difference between a document file stored in the memory 15 and a document file managed by the document management apparatus 20 during the display of a document. Here, a document file managed by the document management apparatus 20 is equivalent to a document file stored in the document DB 232. The difference detection unit 115 compares document files to be synchronized, and detects a different between the two document files. In this exemplary embodiment, the difference detection unit 115 acquires document information on a document file managed by the document management apparatus 20 from the document management apparatus 20 via the communication unit 13. Then, the difference detection unit 115 detects a difference between the acquired document information and document information on a document file stored in the memory 15.

The notification unit 116 is an example of a notification unit according to an exemplary embodiment of the present invention. When the difference detection unit 115 detects a difference, the notification unit 116 notifies the user of information indicating the difference, by displaying the information in an area where the document is being displayed.

When the difference detection unit 115 detects a difference, the document acquisition unit 112 acquires a document file managed by the document management apparatus 20 during the display of a document. In order to synchronize document files, after the currently displayed document has been closed, the memory controller 113 replaces the document file stored in the memory 15 with a document file acquired after the difference has been detected.

The inquiry unit 117 is an example of an inquiry unit according to an exemplary embodiment of the present invention, and inquires the user whether or not to display a document represented by a document file acquired after the difference detection unit 115 has detected a difference, during the display of a document. Here, the inquiry unit 117 gives an inquiry to the user by displaying the inquiry on the display 14.

When the acceptance unit 111 accepts a response to the inquiry given by the inquiry unit 117 indicating that the document is to be displayed, the memory controller 113 replaces the document file. The display controller 114 keeps the currently displayed document displayed during the replacement of the document file. When the replacement is completed, the display controller 114 causes a document represented by the document file (i.e., the document file obtained as a result of replacement) acquired after the difference has been detected.

The controller 21 of the document management apparatus 20 executes the document management application 231 to implement the function corresponding to a document management unit 211.

The document management unit 211 functions as a document manager that manages document files managed in the document DB 232. The document management unit 211 communicates with the terminal apparatus 10 via, for example, the communication unit 22 to transmit a document file or document information to the terminal apparatus 10. Further, in accordance with a request from the terminal apparatus 10, the document management unit 211 performs a process, such as generating a document file to be managed in the document DB 232, updating (or editing) a document, or deleting a document file.

In the document management system 1 having the configuration described above, a document file managed by the document management apparatus 20 is accessible to the multiple terminal apparatuses 10. For this reason, in some cases, for example, after the terminal apparatus 10a has acquired a document file managed by the document management apparatus 20, the managed document file may be updated by the terminal apparatus 10b. In such cases, a process for synchronizing the document file stored in the terminal apparatus 10a with the document file managed by the document management apparatus 20 is performed.

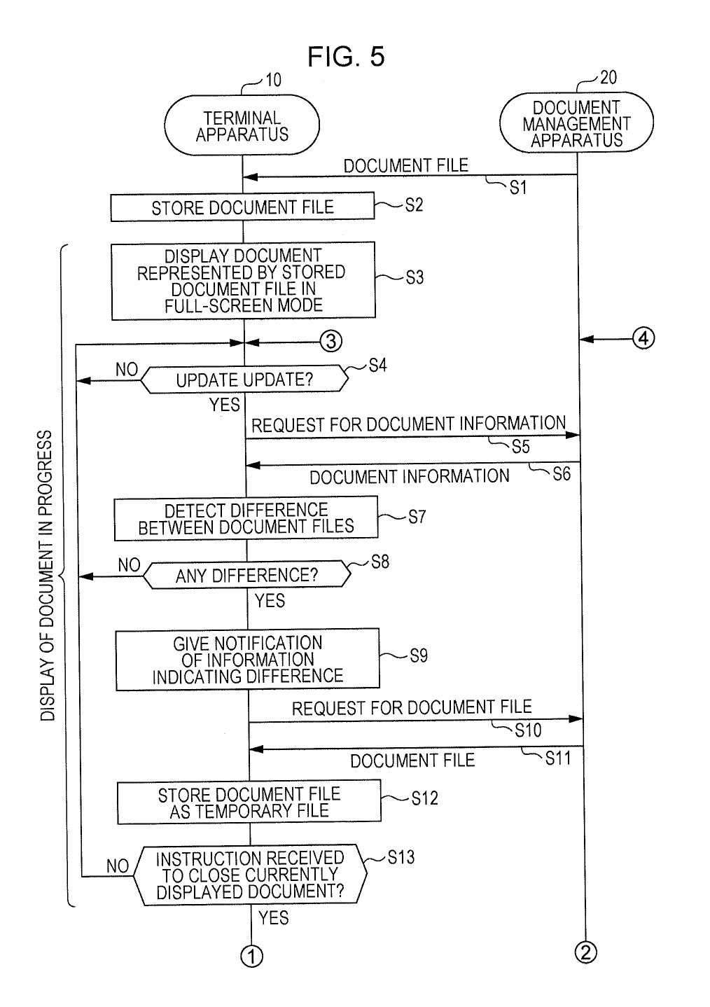

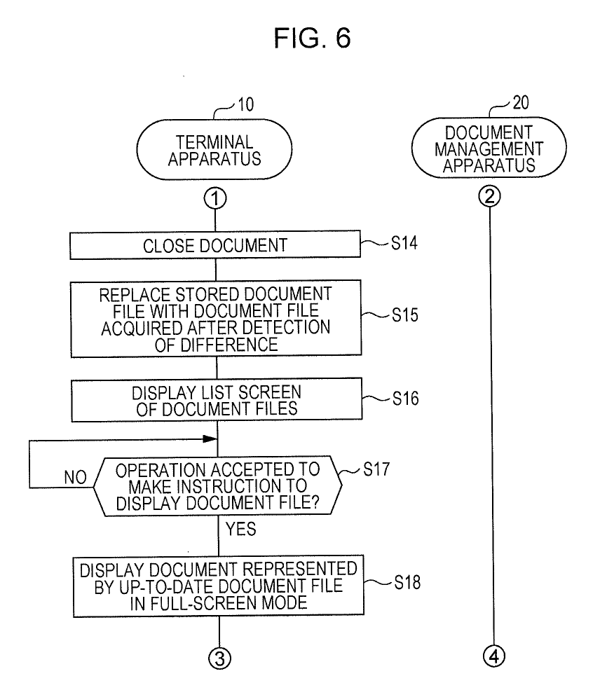

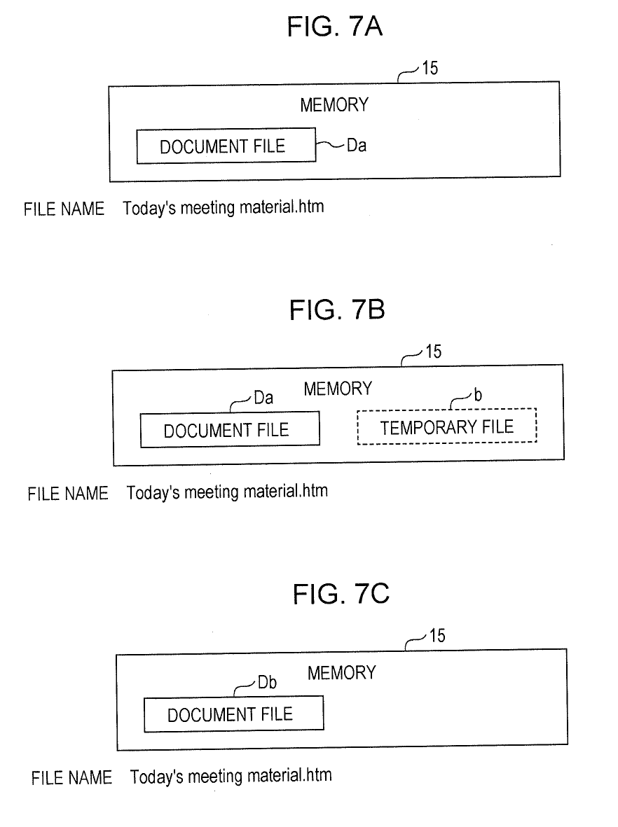

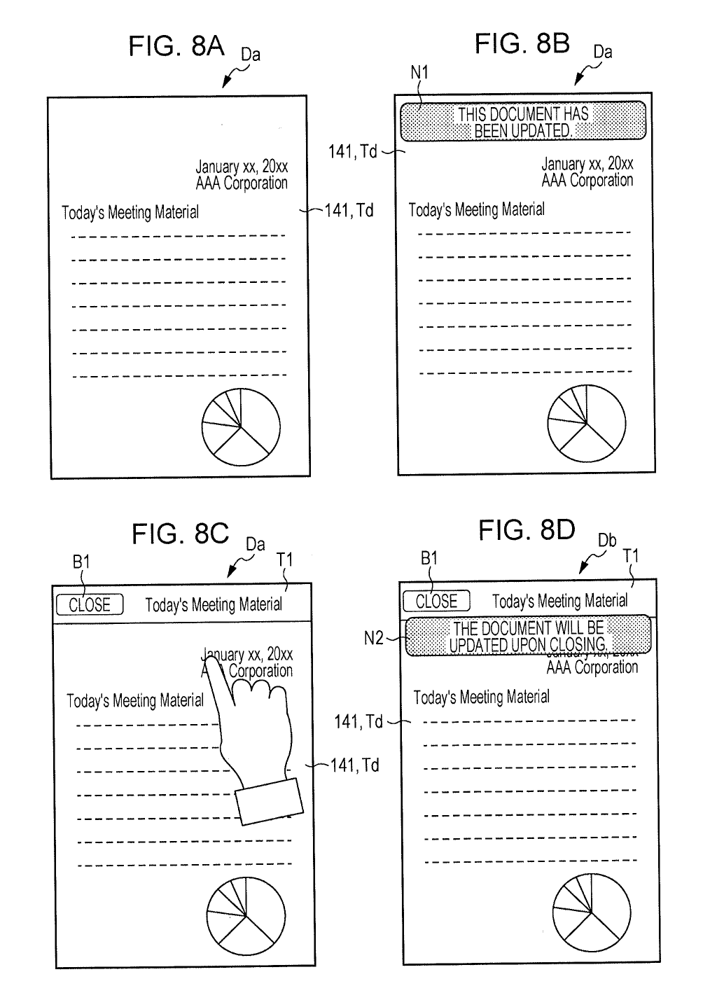

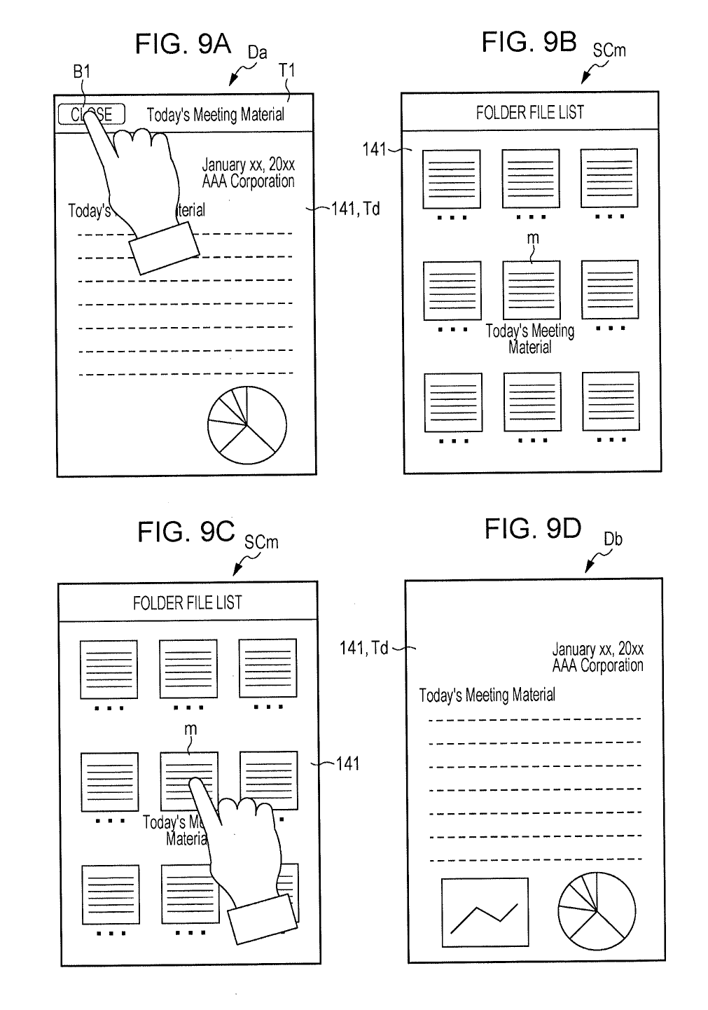

The operation of the terminal apparatus 10 for acquiring a document file from the document management apparatus 20 and displaying a document will be described. FIG. 5 and FIG. 6 are sequence diagrams illustrating a process for the document management system 1 to display a document. FIGS. 7A to 7C illustrate document file storage control in the terminal apparatus 10. FIGS. 8A to 8D and FIGS. 9A to 9D illustrate an example display of documents on the terminal apparatus 10.

First, the controller 11 of the terminal apparatus 10 accesses the document management apparatus 20 via the communication unit 13 to acquire a document file (step S1 in FIG. 5). For example, the controller 11 causes a list screen of document files managed in the document DB 232 to be displayed on the display 14, and accepts an operation of a user to specify a document file via the operation unit 12. The controller 11 requests the document management apparatus 20 to transmit the document file specified by the user, and acquires the document file.

The controller 11 causes the document file acquired in step S1 to be stored in the memory 15 as a document file to be used to display a document (step S2). Here, as illustrated in FIG. 7A, the controller 11 causes a document file Da to be stored in the memory 15. The document file Da has the file name “Today's meeting material.htm”.

Then, the controller 11 causes a document represented by the document file stored in the memory 15 in step S2 to be displayed on the display 14 in full-screen mode (step S3). Here, as illustrated in FIG. 8A, the controller 11 causes a document represented by the document file Da to be displayed so that a document display area Td matches the entire size of the display area 141.

Then, the controller 11 determines whether or not to perform an update check (step S4). The update check is a process for checking the currently displayed document to determine whether or not a document corresponding to a document file managed by the document management apparatus 20 has been updated. For example, the update check is repeatedly performed at predetermined intervals during the display of the document. If it is determined that no update check is performed (NO in step S4), the controller 11 waits.

If it is determined that an update check is performed (YES in step S4), the controller 11 requests the document management apparatus 20 via the communication unit 13 to transmit document information regarding a document file to be synchronized with the document file representing the currently displayed document (step S5). The controller 21 of the document management apparatus 20 acquires the document information from among the document files in the document DB 232 in accordance with the request, and transmits the document information to the terminal apparatus 10 via the communication unit 22 (step S6).

Then, the controller 11 detects a difference between the document files to be synchronized in accordance with the document information (step S7), and determines whether or not there is any difference between them (step S8). When document information regarding the document file stored in the memory 15 and document information regarding the document file managed by the document management apparatus 20 match (here, exactly match), the controller 11 determines that there is no difference between them. When the two pieces of document information do not match (or the two pieces of document information approximately match), it is determined that there is a difference between them. Here, it is determined that there is a difference between the document files when the last update dates and times or file sizes of the document files do not match. Thus, even when the document represented by the document file managed by the document management apparatus 20 has not been modified, it may be determined that the document has been updated.

If it is determined that there is no difference between the document files to be synchronized (NO in step S8), the controller 11 returns the process to step S4.

If it is determined that there is a difference between the document files to be synchronized (YES in step S8), the controller 11 notifies the user of information indicating the detected difference, by displaying the information in a document display area (step S9). Here, as illustrated in FIG. 8B, the controller 11 causes notification information N1 including the message “This document has been updated” to be displayed while the document represented by the document file Da is being displayed in full-screen mode. The notification information N1 is displayed in the document display area Td so as not to impede the user from viewing the document. For example, the controller 11 causes the notification information N1 to be displayed in a background area of the document. The controller 11 may cause the notification information N1 to be displayed at specific time intervals or to disappear after being displayed for a predetermined period of time, rather than always displaying the notification information N1.

Then, the controller 11 requests the document management apparatus 20 via the communication unit 13 to transmit a document file obtained after a difference has been detected (step S10). The controller 21 of the document management apparatus 20 acquires the document file from the document DB 232 in accordance with the accepted request, and transmits the acquired document file to the terminal apparatus 10 via the communication unit 22 (step S11). Upon acquiring the document file via the communication unit 13, the controller 11 stores the document file in the memory 15 as a temporary file (step S12). Here, as illustrated in FIG. 7B, the controller 11 causes the acquired document file to be stored in the memory 15 as a temporary file b separately from the document file Da. In step S12, the controller 11 causes the file path of the temporary file to be stored in the memory 15 in association with the document file representing the currently displayed document. The temporary file may be stored in, for example, a storage area where data that is not used to display a document is stored.

In this exemplary embodiment, the temporary file is stored in the memory 15. Alternatively, the temporary file may be stored in the RAM of the controller 11.

Then, the controller 11 determines whether or not an instruction to close the currently displayed document has been made (step S13). Upon accepting an operation to designate a position in the display area 141 via the operation unit 12, as illustrated in FIG. 8C, the controller 11 causes an information area T1 to be displayed in the display area 141 where the document is being displayed in full-screen mode. The information area T1 is an area having an operator image (or soft button) B1, which is here named “Close”, and showing the file name of the document file named “Today's meeting material”. Then, as illustrated in FIG. 8D, the controller 11 causes notification information N2 including the message “The document will be updated upon closing” to be displayed in the document display area Td of the display 14. Like the notification information N1, the notification information N2 is displayed so as not to impede the user from viewing the document.

If an operation to select the operator image B1 has not been accepted, the controller 11 determines that an instruction to close the currently displayed document has not been made (NO in step S13), and returns the process to step S4. On the other hand, as illustrated in FIG. 9A, if an operation to select the operator image B1 has been accepted, the controller 11 determines that an instruction to close the currently displayed document has been made (YES in step S13), and closes the currently displayed document (step S14 in FIG. 6).

After the document has been closed, the controller 11 replaces the document file representing the document, which is stored in the memory 15, with a document file acquired after the difference has been detected, on the basis of the temporary file stored in step S12 (step S15). Here, as illustrated in FIG. 7C, the controller 11 overwrites the document file Da with the temporary file b to replace the document file Da with a document file Db. The file name of the document file Db is “Today's meeting material.htm”, which is the same as that of the document file Da.

The replacement of a document file may not necessarily be performed by overwrite. For example, after the document file Da has been deleted, the controller 11 may cause the file name of the temporary file b to be changed to the same file name as that of the document file Da, that is, “Today's meeting material.htm”, and then cause the temporary file b to be stored.

Then, the controller 11 causes a list screen of document files used to display a document, which are stored in the memory 15, to be displayed on the display 14 (step S16). As illustrated in FIG. 9B, the controller 11 causes a list screen SCm including a list of icons which are visual representations of the document files stored in the memory 15 to be displayed. The list screen SCm includes an icon corresponding to the document file Db. The list screen SCm is displayed by, for example, a function of the OS.

Then, the controller 11 determines whether or not an operation to make an instruction to display a document represented by a document file has been accepted (step S17). If an operation to designate an icon in the list screen has been accepted, the controller 11 determines “YES” in step S17. As illustrated in FIG. 9C, if an operation to designate an icon m corresponding to the document file Db has been accepted, as illustrated in FIG. 9D, the controller 11 causes a document represented by the document file Db to be displayed on the display 14 in full-screen mode (step S18). Here, as illustrated in FIG. 9D, the controller 11 causes the document represented by the document file Db to be displayed so that the document display area Td matches the entire size of the display area 141.

After the display of the document in full-screen mode is initiated in step S18, the process after step S4 is executed in the document management system 1. The process flow in this case will be easily anticipated from the foregoing description.

As described above, if a document file managed by the document management apparatus 20 has been modified while a document is being displayed in full-screen mode, the terminal apparatus 10 notifies the user of the modification of the document file, while the document is still being displayed, so as not to impede the user from viewing the document. In this case, the terminal apparatus 10 displays notification information in the document display area Td, allowing the user to easily recognize that the document has been updated. In addition, the terminal apparatus 10 updates the document file after the currently displayed document has been closed, and displays the updated document next time the document file is opened. This may avoid any inconvenience caused by the replacement of a document file in which a user who wishes to view the currently displayed document will be impeded from viewing the document.

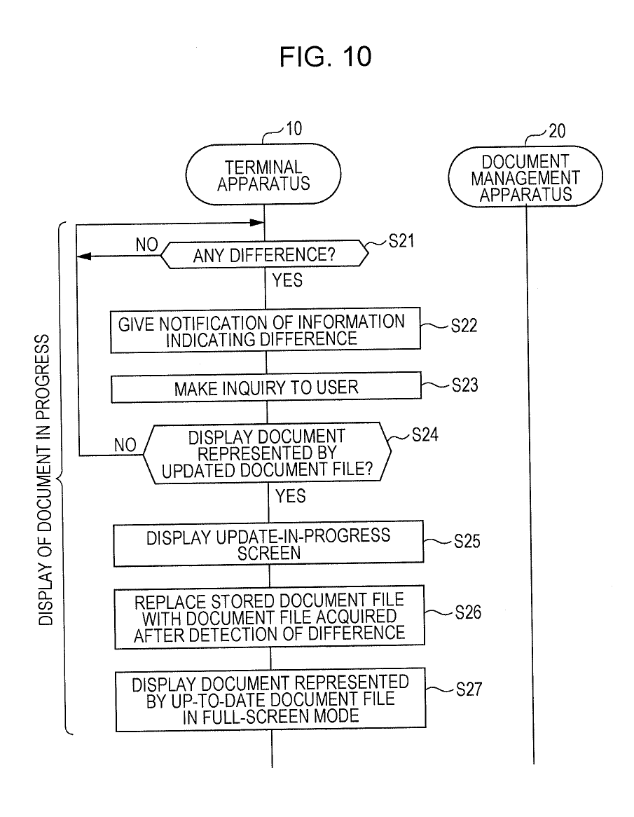

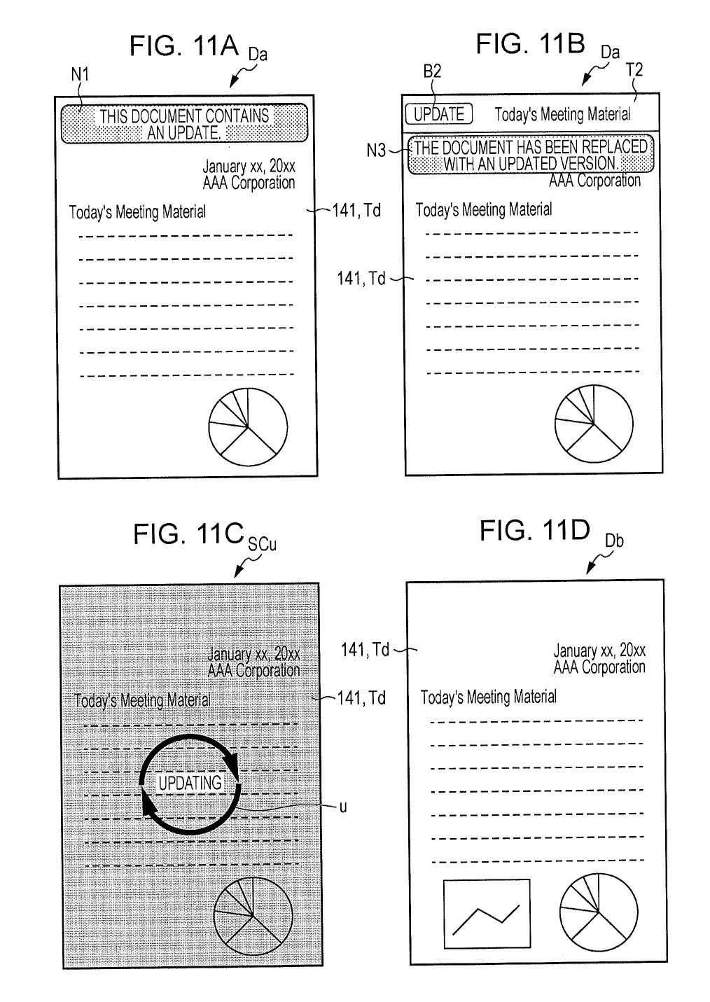

In addition to or instead of the configuration described above, the terminal apparatus 10 may replace a document file during the display of a document. FIG. 10 is a sequence diagram illustrating a process for the document management system 1 to update a document. FIGS. 11A to 11D illustrate an example display of documents on the terminal apparatus 10.

The controller 11 of the terminal apparatus 10 determines whether or not a difference between document files to be synchronized has been detected during the display of a document (step S21). Here, the controller 11 performs the determination by using the method described with reference to step S5 to S7 in FIG. 5. If “YES” is determined in step S21, the controller 11 notifies the user of the presence of the difference by displaying the notification in a document display area (step S22). Here, the controller 11 displays notification information N1 including a message indicating that there is a difference between the document files by using the method described with reference to step S8 in FIG. 5 (see FIG. 11A).

After that, upon accepting an operation to designate a position in the display area 141 via the operation unit 12, the controller 11 inquires the user whether or not to display a document obtained after the document file has been modified (step S23). Here, as illustrated in FIG. 11B, the controller 11 causes an information area T2 to be displayed in the display area 141 where the document is being displayed in full-screen mode. The information area T2 is an area having an operator image B2 named “Update” and showing the file name of the document file named “Today's meeting material”. The controller 11 further causes notification information N3 including the message “The document has been replaced with an updated version” to be displayed in the document display area Td of the display 14. The notification information N3 is displayed so as not to impede the user from viewing the document in a manner similar to that for the notification information N1 and the notification information N2.

Then, the controller 11 determines whether or not to display a document represented by the modified document file (step S24). If an operation to select the operator image B2 has not been accepted, the controller 11 determines that the document represented by the modified document file is not displayed (NO in step S24), and returns the process to step S21.

On the other hand, if an operation to select the operator image B2 has been accepted, the controller 11 determines that the document represented by the modified document file is displayed (YES in step S24), and causes an update-in-progress screen to be displayed on the display 14 (step S25). The update-in-progress screen is a screen (screen image) showing the currently displayed document. Here, as illustrated in FIG. 11C, the controller 11 causes an update-in-progress screen SCu on which a graphical element u indicating that the update is in progress is superimposed on the currently displayed document represented by the document file Da to be displayed. The controller 11 further causes an update-in-progress screen to be displayed without using the document file (here, the document file Da) of the document displayed immediately before the update-in-progress screen is displayed. The controller 11 causes an update-in-progress screen to be displayed in accordance with, for example, image data (for example, bitmap data stored in the VRAM) generated by capturing a screen on which a document is being displayed, a document file created by cutting the document corresponding to the currently displayed page, or copy data of the document file representing the currently displayed document.

After the display of an update-in-progress screen is initiated, the controller 11 replaces the document file corresponding to the document displayed immediately before the update-in-progress screen is displayed, which is stored in the memory 15, with a document file acquired after the difference has been detected, on the basis of the temporary file stored in step S12 (step S26). The processing of step S26 may be substantially the same as that of step S15.

Then, the controller 11 causes a document represented by the document file obtained as a result of replacement in step S26 to be displayed on the display 14 in full-screen mode (step S27). Here, as illustrated in FIG. 11D, the controller 11 causes the document represented by the document file Db to be displayed so that the document display area Td matches the entire size of the display area 141. In this case, the controller 11 causes the document represented by the document file obtained as a result of replacement to be displayed at the position at which the document was being displayed at the time of replacement. Here, the controller 11 causes the document corresponding to the same page to be displayed before and after replacement. This may prevent the last viewed position (or page) of the document from being changed even when the document file is replaced.

The controller 11 may make other display conditions of a document, in addition to the position of the document, including the display magnification of the document (100% for standard) and the rotation angle (for example, rotation angle in clockwise direction) of a document displayed with rotation, the same before and after the replacement of a document file.

### MODIFICATIONS

The present invention may provide some other different exemplary embodiments than that described above. The following modifications may be used in combination.

### First Modification

In step S9, in addition to notifying the user of the presence of a difference between document files to be synchronized, the terminal apparatus 10 may notify the user of information indicating a portion in which a difference is present in a document.

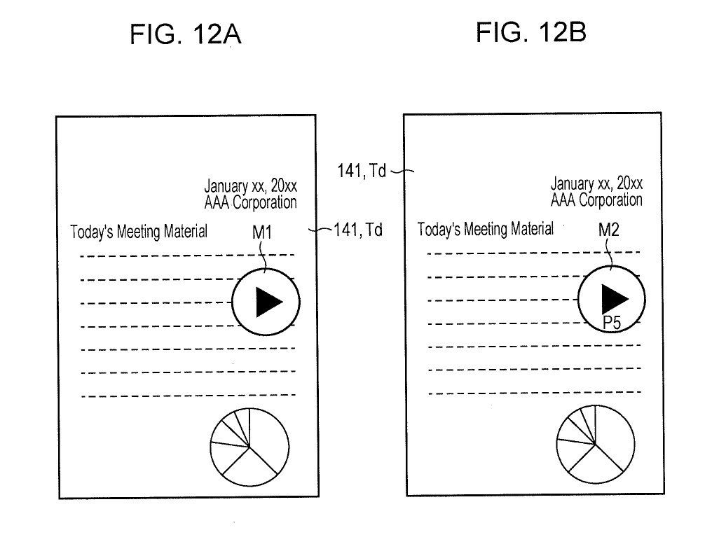

FIGS. 12A and 12B illustrate an example display of documents on the terminal apparatus 10 according to this modification. As illustrated in FIG. 12A, the controller 11 causes information indicating a page in which a document has been modified (or updated) to be displayed in the document display area Td. In the example illustrated in FIG. 12A, the controller 11 causes an indicator image M1 indicating that the updated page appears after the page corresponding to the currently displayed document to be displayed. Although not illustrated in the drawings, if a page before the page corresponding to the currently displayed document has been updated, the controller 11 causes an indicator image indicating the presence of the updated page before the page corresponding to the currently displayed document to be displayed.

Any specific method for an update check for each page may be used. For example, document information may include information (for example, timestamp) on the last update date and time for each page. In this case, the controller 11 detects an updated page in accordance with the document information. The controller 11 may compare documents indicated by document files on a page-by-page basis to detect a difference between them, or may refer to the data size of each page to detect a difference between them.

The controller 11 may notify the user of, in addition to the direction of the updated page, information indicating the page number of the updated page. For example, as illustrated in FIG. 12B, the controller 11 causes an indicator image M2 having the page number of the updated page to be displayed.

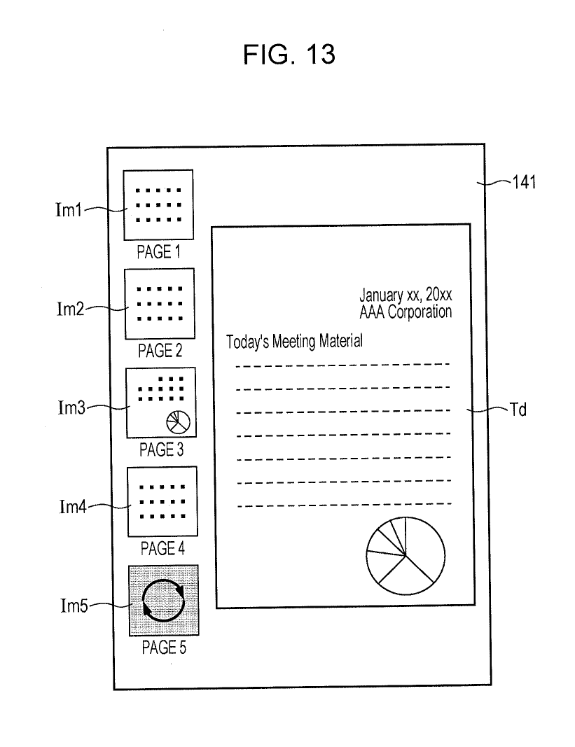

FIG. 13 illustrates another example display of documents on the terminal apparatus 10 according to this modification. Upon detection of a difference between document files while a document is being displayed in full-screen mode, as illustrated in FIG. 13, a portion of the display area 141 is used as the document display area Td, and the controller 11 causes thumbnail images (here, Im1 to Im5) indicating thumbnails of documents on other pages to be displayed in an area other than the document display area Td. One thumbnail image is displayed for each page in a document file. Upon acceptance of an operation to designate a display position of a thumbnail image, the controller 11 causes the document corresponding to the page associated with the thumbnail image to be displayed in the display area 141. If a difference is detected, the controller 11 causes a thumbnail image corresponding to the page on which the difference has been detected to be displayed using a display method to indicate the page on which the difference has been detected. In the example illustrated in FIG. 13, the thumbnail image Im5 corresponding to page 5 is displayed in such a manner that the presence of a document update is indicated.

By being notified of information indicating the position of a document in which a difference has been detected, the user may be able to easily make an instruction to perform an update-related process, such as not making an instruction to replace a document file when a document corresponding to a page that has already been referred to is updated, and making an instruction to replace a document file when a document corresponding to a page that is yet to be referred to is updated.

### Second Modification

Instead of replacing a document file on the basis of a temporary file, the terminal apparatus 10 may store a document file acquired after a difference has been detected in the memory 15 separately from the stored document file.

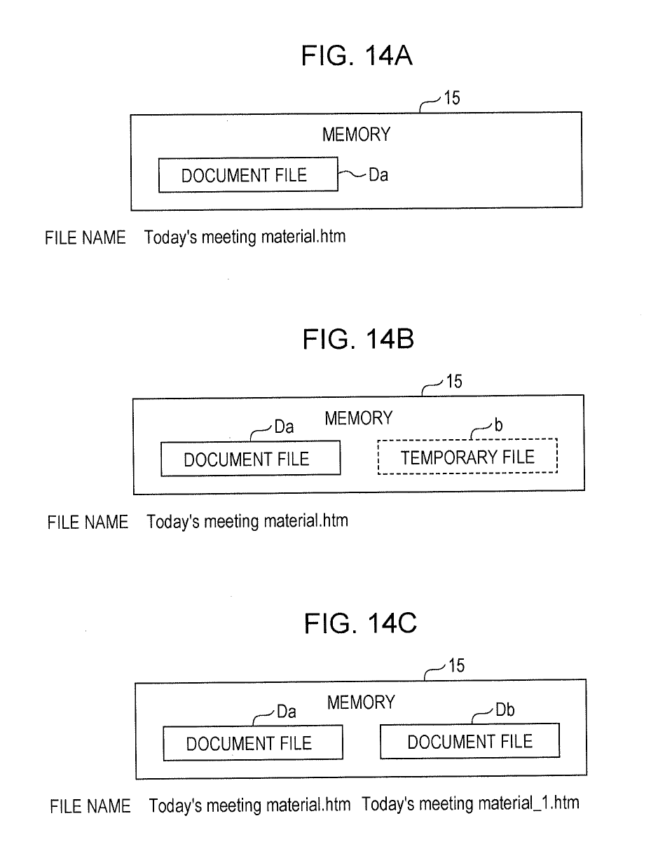

FIGS. 14A to 14C illustrate document file storage control performed by the terminal apparatus 10 according to this modification. Here, as illustrated in FIG. 14A, the document file Da with the name “Today's meeting material.htm” is stored in the memory 15, and, as illustrated in FIG. 14B, a temporary file b is further stored in the memory 15. In this case, when the temporary file b is to be stored in the controller 11 as a document file, the file name of the temporary file b is set to a file name different from that of the stored document file. To this end, the controller 11 may allow the user to set a file name at the time when a document file is stored in the memory 15. The controller 11 may also set a file name in accordance with a predetermined rule so as not to match the file name of the stored document file. For example, in a case where a file with the file name “Today's meeting material.htm” is stored, the controller 11 sets the file name “Today's meeting material_{—}1.htm”.

The terminal apparatus 10 may inquire the user whether to store a document file by replacing an existing stored document file or to store a document file separately from an existing stored document file without replacing it, each time a document file is stored, and may perform storage control in accordance with instructions from the user.

### Third Modification

The configuration and operation described in the foregoing exemplary embodiment may be omitted or modified in part.

In the foregoing description, the terminal apparatus 10 displays a document represented by a document file in full-screen mode. Alternatively, the terminal apparatus 10 may display a document represented by a document file with a window frame or in a window with a size changed by a user, by way of example. In addition, when displaying a notification area by a function of the OS or the like, the terminal apparatus 10 may display a document in an area other than the notification area within the display area 141. When a document is not displayed in full-screen mode, the terminal apparatus 10 may simultaneously display documents corresponding to two or more pages.

The terminal apparatus 10 may replace a document file with a document file acquired after a difference has been detected, without notifying the user of information indicating the detected difference.

The function of the difference detection unit 115 in the foregoing exemplary embodiment may be omitted, and the notification unit 116 and the document acquisition unit 112 may execute the above-described function when there is a difference between a document file stored in the memory 15 and a document file managed by the document management apparatus 20.

The document management apparatus 20 instead of the terminal apparatus 10 may determine the timing of an update check, and may transmit document information to the terminal apparatus 10.

The memory 15 may have a configuration in which a storage area for a document file used to display a document and a storage area for a temporary file not used to display a document are physically or logically separated.

A display control device according to an exemplary embodiment of the present invention may perform display control to display various screens on a display included in an external device.

A display control device according to an exemplary embodiment of the present invention may store an acquired document file in an external memory instead of in an internal memory of the terminal apparatus.

The display of images described above, such as the display of documents and the display of notification information indicating a detected difference is merely an example.

### Fourth Modification

The functions implemented by the controller 11 of the terminal apparatus 10 and the controller 21 of the document management apparatus 20 in the foregoing exemplary embodiment may be implemented by one or multiple hardware circuits, or may be implemented by the execution of one or multiple programs or by a combination of them. When the functions of the controllers 11 and 21 are implemented using a program, the program may be stored in a computer-readable recording medium, such as a magnetic recording medium (such as a magnetic tape or a magnetic disk (such as a hard disk drive (HDD) or a flexible disk (FD))), an optical recording medium (such as an optical disk), a magneto-optical recording medium, or a semiconductor memory before being provided, or may be distributed via a network.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control device comprising:
a memory controller that causes a document file managed by a document management apparatus to be stored in a memory;
a display controller that causes a document represented by the document file stored in the memory to be displayed over an entire range of a display area of a display during a presentation; and
a notification unit that notifies a user of presence of a difference between the document file stored in the memory and the document file managed by the document management apparatus, while the document is being displayed over the entire range of the display area, by displaying the difference in an area where the document is being displayed.

2. The display control device according to claim 1, further comprising:
an acquisition unit that, by using occurrence of the difference as a trigger, acquires the document file managed by the document management apparatus from the document management apparatus while the document is being displayed.

3. The display control device according to claim 2, wherein the memory controller replaces the document file stored in the memory with the acquired document file which is managed by the document management apparatus, after the document being displayed is closed.

4. The display control device according to claim 3, further comprising:
an inquiry unit that makes an inquiry to the user about whether or not a document represented by the acquired document file which is managed by the document management apparatus is to be displayed, while the document is being displayed,
wherein upon receipt of a response to the inquiry indicating that the document represented by the acquired document file which is managed by the document management apparatus is to be displayed, the memory controller replaces the document file stored in the memory with the acquired document file which is managed by the document management apparatus, and
wherein the display controller keeps the document, which is being displayed, displayed while replacement of the document file stored in the memory with the acquired document file which is managed by the document management apparatus is being performed, and causes the document represented by the acquired document file which is managed by the document management apparatus to be displayed after the replacement is completed.

5. The display control device according to claim 4, wherein the display controller causes the document represented by the acquired document file which is managed by the document management apparatus to be displayed at a position at which the document represented by the document file stored in the memory was being displayed at a time of the replacement.

6. The display control device according to claim 1, wherein the notification unit notifies the user of the presence of the difference by displaying the difference at a predetermined position in the display area.

7. The display control device according to claim 1, wherein, in response to the presence of the difference, the notification unit notifies the user of information indicating a position in which the difference is present.

8. The display control device according to claim 7, wherein the notification unit notifies the user of, while displaying a given page of the document based on the document file stored in the memory, information indicating one or more other pages including a page on which the difference is present.

9. A terminal apparatus comprising:
the display control device according to claim 1;
the memory that stores a document file managed by the document management apparatus; and
the display that displays a document represented by the document file stored in the memory.

10. A non-transitory computer readable medium storing a program causing a computer to execute a process for display control, the process comprising:
causing a document file managed by a document management apparatus to be stored in a memory;
causing a document represented by the document file stored in the memory to be displayed over an entire range of a display area of a display during a presentation; and
notifying a user of presence of a difference between the document file stored in the memory and the document file managed by the document management apparatus, while the document is being displayed over the entire range of the display area, by displaying the difference in an area where the document is being displayed.

11. A display control method comprising:
causing a document file managed by a document management apparatus to be stored in a memory;
causing a document represented by the document file stored in the memory to be displayed over an entire range of a display area of a display during a presentation; and
notifying a user of presence of a difference between the document file stored in the memory and the document file managed by the document management apparatus, while the document is being displayed over the entire range of the display area, by displaying the difference in an area where the document is being displayed.
